(19) United States
(12) Patent Application Publication
(10) Pub. No.: US 2008/0291920 A1
(43) Pub. Date: Nov. 27, 2008

(54) SYSTEM AND METHOD FOR MANAGING COMMUNICATIONS

(75) Inventors: YETIK SERBEST, AUSTIN, TX (US); ERIC PUETZ, GEORGETOWN, TX (US); WENGE CHEN, AUSTIN, TX (US); MICHAEL PEPE, AUSTIN, TX (US); WEIJING CHEN, AUSTIN, TX (US)

Correspondence Address: AKERMAN SENTERFITT, P.O. BOX 3188, WEST PALM BEACH, FL, 33402-3188, US

(73) Assignee: AT&T KNOWLEDGE VENTURES, L.P., RENO, NV (US)

(21) Appl. No.: 11/751,460

(22) Filed: May 21, 2007

(51) Int. Cl. H04L 12/56

(52) U.S. Cl. 370/395.31

(57) ABSTRACT

A system and method for managing communications is disclosed. A system that incorporates teachings of the present disclosure may include, for example, a communication device having a controller element to transmit a packet along a logical tunnel established through an internet service provider, wherein the route of the packet is managed according to a MPLS label of the packet and a VRF routing table. Additional embodiments are disclosed.

### FIELD OF THE DISCLOSURE

The present disclosure relates generally to communication systems, and more specifically to a system and method for managing communications.

### BACKGROUND

As businesses and the population expand, the providing of inter-city/long-haul communication services becomes more desirable. Inter-city/long-haul communication services can be provided by building an overlay inter-LATA network by laying down fiber; by leasing dark fiber from a long distance service provider; by leasing wavelengths from a long distance service provider; and by leasing circuits such as Packet over SONET (POS), Frame Relay, and ATM from a long distance service provider. However, each of these options can be very expensive and can be a time consuming process. The cost and time spent can be exacerbated by the particular location of the overlay network and its extent.

A need therefore arises for a system and method for managing communications.

### BRIEF DESCRIPTION OF THE DRAWINGS

FIGS. 1-4 depict exemplary embodiments of a communication system;

FIG. 5 depicts an exemplary method operating in one or more of the communication systems of FIGS. 1-4; and

FIG. 6 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide a system and method for managing communications.

In a first embodiment of the present disclosure, a computer-readable storage medium, in a network proxy of a first communication system, can have computer instructions for establishing internet access through an internet service provider; establishing a Generic Route Encapsulation (GRE) tunnel to a second communication system through the internet service provider; establishing VRF functionality in a border router of the first communication system that uses MPLS protocol; and routing a packet from the first communication system to the second communication system along the GRE tunnel according to a MPLS label of the packet and a VRF routing table.

In a second embodiment of the present disclosure, a method of providing a communication service between first and second service providers, can involve establishing a logical tunnel to the first and second service providers utilizing an internet service provider; and routing a packet along the logical tunnel between the first and second service providers according to a MPLS label of the packet and a VRF routing table.

In a third embodiment of the present disclosure, a communication device can have a controller element to transmit a packet along a logical tunnel established through an internet service provider, wherein the route of the packet is managed according to a MPLS label of the packet and a VRF routing table.

In a fourth embodiment of the present disclosure, a network element of a first communication system can have a controller element to receive a packet from a second communication system along a Generic Route Encapsulation (GRE) tunnel according to a MPLS label of the packet and a VRF routing table, wherein the GRE tunnel is established through an internet service provider.

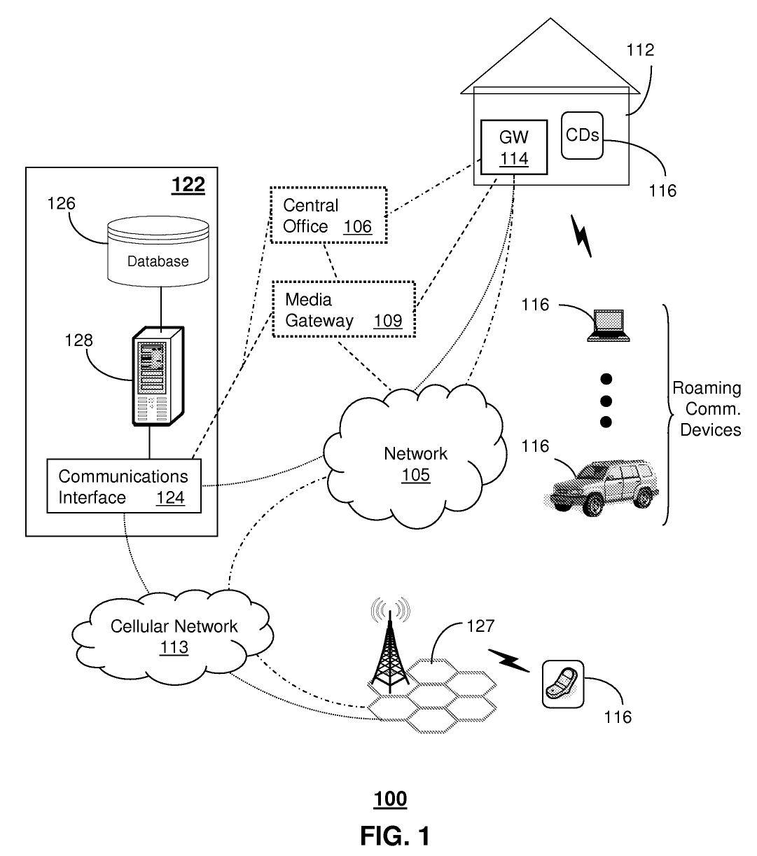

FIG. 1 depicts an exemplary block diagram of a communication system 100 that can supply communication services to one or more fixed and/or roaming communication devices 116. The communication system 100 can comprise a central office (CO) 106 coupled to one or more buildings 112. The CO 106 can house common network switching equipment (e.g., circuit-switched and packet-switched switches and routers) for distributing local and long-distance telecommunication services supplied by network 105 to buildings 112 (such as dwellings or commercial enterprises). For illustration purposes only, buildings 112 can be referred to herein as residences 112. However, it should be understood by one of ordinary skill in the art that the buildings 112 can refer to any premises or areas that utilize communication services. Telecommunication services of the CO 106 can include traditional POTS (Plain Old Telephone Service) and broadband services such as HDTV, DSL, VoIP (Voice over Internet Protocol), IPTV (Internet Protocol Television), Internet services, and so on. The communication devices 116 can be a portable or fixed VoIP, PSTN, and/or cellular terminal. However, the present disclosure contemplates the use of other types of communication devices, including other types of voice, video and data devices.

As a packet-switched network, network 105 can represent an Internet Service Provider (ISP) network. The network 105 can be coupled to a network proxy 122, a cellular network 113 and network elements, including network elements located in one or more of the buildings 112. As a circuit-switched network, network 105, can provide PSTN services to fixed communication devices 116. In a combined embodiment, network 105 can utilize technology for transporting Internet, voice, and video traffic.

In an enterprise setting, the building 112 can include a gateway 114 that provides voice and/or video connectivity services between communication devices 116, such as VoIP terminals or other forms of communication devices of enterprise personnel. In a residential setting, the building 112 can include a gateway 114 represented by, for example, a residential gateway coupled to central office 106 utilizing conventional telephonic switching for processing calls with third parties.

The network proxy 122 can be used to control operations of a media gateway 109, the central office 106 and/or the gateway 114. Communications between the network proxy 122, the communication devices 116 and other network elements of the communication system 100 can conform to any number of signaling protocols such as a session initiation protocol (SIP), or a video communications protocol such as H.323 which combines video and voice over a packet-switched network.

The network proxy 122 can comprise a communications interface 124 that utilizes common technology for communicating over an IP interface with the network 105, the media gateway 109, the cellular network 113, and/or the gateway 114. By way of the communications interface 124, the network proxy 122 can direct by common means any of the foregoing network elements to establish packet switched data, voice, and/or video connections between communication devices 116 distributed throughout the communication system 100. The network proxy 122 can further comprise a memory 126 (such as a high capacity storage medium) embodied in this illustration as a database, and a controller 128 that makes use of computing technology such as a desktop computer, or scalable server for controlling operations of the network proxy 122. The network proxy 122 can operate as an IP Multimedia Subsystem (IMS) conforming in part to protocols defined by standards bodies such as 3GPP (Third Generation Partnership Protocol).

Under the control of the network proxy 122, the media gateway 109 can link packet-switched and circuit-switched technologies such as the cellular network 113 (or central office 106) and the network 105, such as an ISP network. The media gateway 109 can conform to a media gateway control protocol (MGCP) also known as H.248 defined by work groups in the Internet Engineering Task Force (IETF). This protocol can handle signaling and session management needed during a multimedia conference. The protocol defines a means of communication which converts data from the format required for a circuit-switched network to that required for a packet-switched network. MGCP can therefore be used to set up, maintain, and terminate calls between multiple disparate network elements of the communication system 100. The media gateway 109 can therefore support hybrid communication environments for communication devices 116, including VoIP terminals.

The cellular network 113 can support voice and data services over a number of access technologies such as GSM-GPRS, EDGE, CDMA-1X, UMTS, WiMAX, software defined radio (SDR), and other known and future technologies. The cellular network 113 can be coupled to base stations 127 under a frequency-reuse plan for communicating over-the-air with roaming VoIP terminals 116. The communication system 100 can utilize common computing and communications technologies to support circuit-switched and/or packet-switched communications, including MPLS.

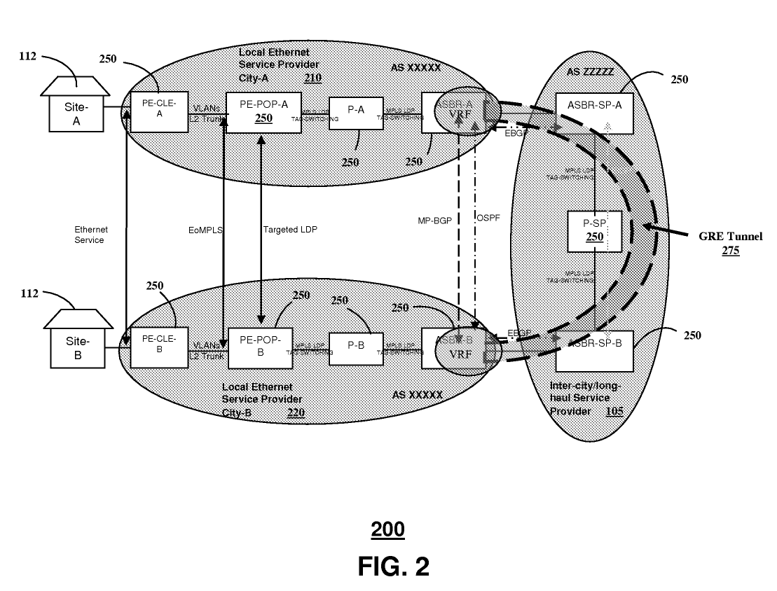

FIG. 2 depicts an exemplary embodiment of a communication system 200 that can include the ISP network 105 and two or more local access and transport areas (LATAs) or networks 210 and 220, such as local Ethernet service provider networks. The communication system 200 can be overlaid or operably coupled with communication system 100 as another representative embodiment of communication system 100. In one embodiment, the LATAs 210 and 220 can comprise virtual local area networks (VLANs), such as VLAN hand-offs to customer sites, such as Sites A and B of buildings 112.

The geographic area of the network 105 and LATAs 210 and 220 can vary. In one embodiment, network 105 can be a long-haul Internet service provider capable of operating over large distances, such as inter-city, inter-state, and international communications. In one embodiment, the LATAs 210 and 220 can be located in different cities or other distinct areas.

Each of the network 105 and LATAs 210 and 220 can comprise network elements 250 for communication, including routers for transmitting packets over each of the networks and between the networks. The routers can include provider routers (P), such as provider edge routers (PE) that are customer location equipment (PE-CLE) and point of presence (PE-POP), and autonomous system border routers (ASBR). A logical tunnel 275, such as a Generic Routing Encapsulation tunnel (GRE) can be established between the LATAs 210 and 220 over the network 105. The packets can be transmitted according to various protocols and combinations of protocols, including Border Gateway Protocol (BGP), External Border Gateway Protocol (EBGP), Ethernet over MPLS (EoMPLS), Internal Border Gateway Protocol (IBGP), Internet Protocol (IP), Layer-2 Tunneling Protocol version 3 (L2TPv3), Label Distribution Protocol (LDP), Multi-Protocol Border Gateway Protocol (MP-BGP), Multi-Protocol Label Switching (MPLS), Open Shortest Path First (OSPF), and Virtual Routing and Forwarding (VRF).

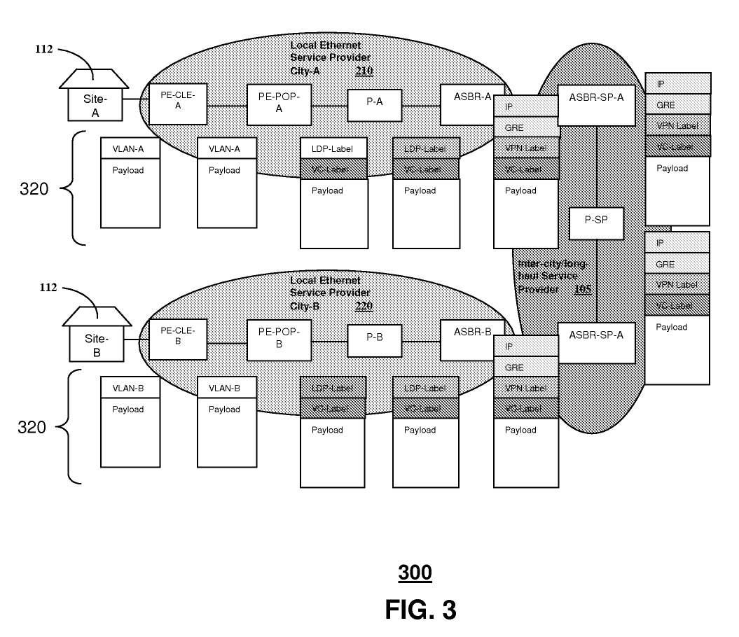

FIG. 3 depicts an exemplary embodiment of a communication system 300 that can include the ISP network 105 and the LATAs 210 and 220, and can transmit a packet from a first building 112 (i.e., Site A) to a second building (i.e., Site B). The communication system 300 can be overlaid or operably coupled with communication systems 100 and/or 200 as another representative embodiment of the systems.

Communication system 300 can transmit packet 320 with various tags provided by the various network elements 250, including VLAN, LDP, VC, IP, GRE, and VPN. The packet 320 can be transmitted from Site A to Site B without changing the VC-Label. Packet 320 can also be transmitted over the inter-city/long-haul service provider network 105 without the GRE header, IP header and VPN label being changed. In one embodiment, the services that the local Ethernet service provider is offering by way of LATAs 210 and 220 to Sites A and B can be done so without the inter-city/long-haul service provider being made aware.

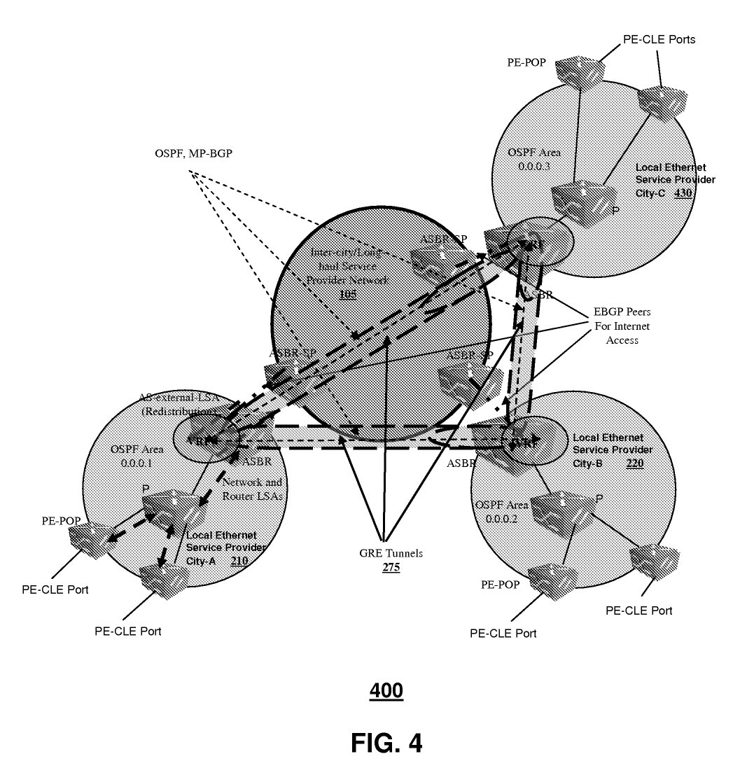

FIG. 4 depicts an exemplary embodiment of a communication system 400 that can include the ISP network 105, the LATAs 210 and 220, and additional networks, such as a LATA 430, which can be a local Ethernet service provider network. The communication system 400 can be overlaid or operably coupled with communication systems 100, 200 and/or 300 as another representative embodiment of the systems. The geographic area of the network 105 and LATAs 210, 220 and 430 can vary. In one embodiment, network 105 can be a long-haul Internet service provider capable of operating over large distances, such as inter-city, inter-state, and international communications, and each of the LATAs 210, 220 and 430 can be located in different cities or other distinct areas. The present disclosure contemplates using other numbers and configurations of LATAs, as well other numbers and configurations of ISP networks.

Similar to the LATAs 210 and 220, the LATA 430 can comprise network elements 250 for communication, including routers for transmitting packets over each of the networks and between the networks. The routers can include provider routers 4(P), such as provider edge routers (PE) that are customer location equipment (PE-CLE) and point of presence (PE-POP), and autonomous system border routers (ASBR). Logical tunnels 275, such as a Generic Routing Encapsulation tunnel (GRE), can be established between the LATAs 210, 220 and 430 over the network 105. The packets 320 can be transmitted according to various protocols and combinations of protocols, including BGP, EBGP, EoMPLS, IBGP, IP, L2TPv3, LDP, MP-BGP, MPLS, OSPF, and VRF.

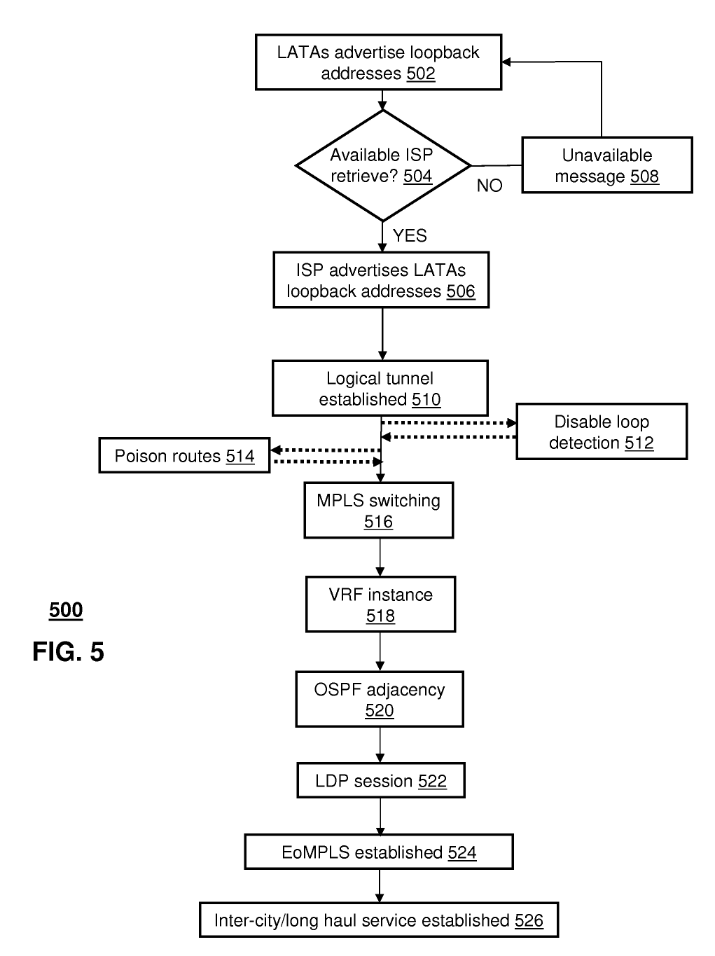

FIG. 5 depicts an exemplary method 500 operating in portions of communication systems 100, 200, 300, and/or 400. Method 500 has variants as depicted by the dashed lines and is described with reference also to FIGS. 1-4. It would be apparent to an artisan with ordinary skill in the art that other embodiments not depicted in FIG. 5 are possible without departing from the scope of the claims described below.

Method 500 begins with step 502 in which network elements 250 of LATAs 210 and 220 can advertise their loopback address to one or more available ISP networks 105. For example, ASBR-A can advertise ASBR-A's /32 IPv4 loopback address to ASBR-SP-A. Similarly, ASBR-B can advertise ASBR-B's /32 IPv4 loopback address to ASBR-SP-B. These loopback address can be advertised through suitable protocol, such as EBGP.

In step 504, the LATAs 210 and 220 can determine if an ISP network 105 is available. If an ISP network 105 is available and retrieves the loopback addresses then the network elements 250 of the ISP network can advertise the loopback addresses of the network elements of the LATA's 210 and 220, as in step 506. For example, the ASBR-SP-A can advertise ASBR-A's /32 IPv4 loopback address to ASBR-SP-B. Similarly, ASBR-SP-B can advertise ASBR-B's /32 IPv4 loopback address to ASBR-SP-A. These loopback address can be advertised through suitable protocol, such as IBGP. ASBR-SP-B can then advertise ASBR-A's /32 IPv4 loopback address to ASBR-B with ASBR-SP-B as the next hop. Similarly, ASBR-SP-A can advertise ASBR-B's /32 IPv4 loopback address to ASBR-A with ASBR-SP-A as the next hop. These loopback address can be advertised through suitable protocol, such as EBGP. If on the other hand an ISP network 105 is unavailable, then the LATAs 210 and 220 can notify the users (e.g., an unavailability message in step 508) and/or continue to advertise the loopback addresses.

In step 510, the LATAs 210 and 220 can establish a logical tunnel over the ISP network 105 based upon the receipt of the loopback addresses. In one embodiment, the logical tunnel can be the GRE tunnel 275. For example, the ASBR-A and ASBR-B can utilize the loopback addresses received to establish the GRE tunnel over the ISP network 105 between each other.

In one embodiment, the LATAs 210 and 220 can have the same autonomous system (AS) number. The LATAs 210 and 220 can disable a loop detection function to prevent an erroneous detection of a loop caused by use of the same AS number, as in step 512. In another embodiment, the LATAs 210 and 220 can poison the routes to prevent routing loops, such as through use of distance-vector routing protocols and indicating to one or more routers that a route is no longer reachable, as in step 514.

With a logical tunnel established between network elements 250 of LATAs 210 and 220, such as between ASBR-A and ASBR-B, a VRF functionality can be established in ASBR-A and ASBR-B. In step 516, MPLS switching can be turned on in VRF instances. In step 518, a VRF instance can be included in an OSPF routing protocol instance of the LATAs 210 and 220 (e.g., local Ethernet service provider networks).

With the VRF functionality established between the network elements 250 of LATAs 210 and 220, OSPF adjacency through the GRE tunnel 275 can be established, as in step 520. The OSPF can allow the ASBR-A and ASBR-B to exchange all the routes between each other. In step 522, a targeted LDP session can be established between network elements 250 of the LATAs 210 and 220, such as PE-POP-A and PE-POP-B. In step 524, an Ethernet over MPLS (EOMPLS) virtual circuit (VC) can be established between network elements 250 of the LATAs 210 and 220, such as PE-POP-A and PE-POP-B. For example, the PE-POP-A can advertise the VC label for VLAN-A to PE-POP-B via the targeted LDP session, and the PE-POP-B can advertise the VC label for VLAN-B to PE-POP-A via the targeted LDP session.

With the EoMPLS virtual circuit established between network elements 250 of the LATAs 210 and 220, an inter-city/long-haul Ethernet service between PE-CLE-A and PE-CLE-B can be established, as in step 526. For example, a port between PE-CLE-A and Site-A can be configured as a trunk port, and VLAN-A can be added to that port. Similarly, a port between PE-CLE-B and Site-B can be configured as a trunk port, and VLAN-B can be added to that port. A port between PE-CLE-A and PE-POP-A can be configured as a trunk port, and VLAN-A can be added to that port. Similarly, a port between PE-CLE-B and PE-POP-B can be configured as a trunk port, and VLAN-B can be added to that port. The communication of packets 320 can be managed according to MPLS switching and the VRF functionality.

From the foregoing descriptions, it would be evident to an artisan with ordinary skill in the art that the aforementioned embodiments can be modified, reduced, or enhanced without departing from the scope and spirit of the claims described below. For example, the LATAs 210 and 220 can establish other types of logical tunnels over the ISP network 105, such as a L2TP tunnel. The number and configuration of the LATAs can be such that a local Ethernet service provider can establish its own overlay network, which is a logical overlay network, and can provide other services, such as IP-VPN, so as to become a virtual ISP. These are but a few examples of the modifications that can be applied to the present disclosure without departing from the scope of the claims. Accordingly, the reader is directed to the claims for a fuller understanding of the breadth and scope of the present disclosure.

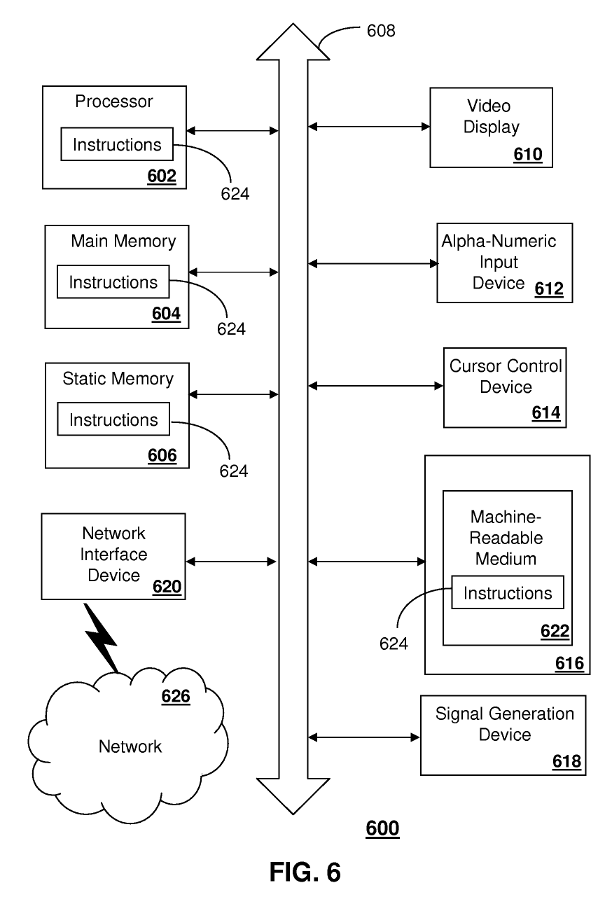

FIG. 6 depicts an exemplary diagrammatic representation of a machine in the form of a computer system 600 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 600 may include a processor 602 (e.g., a central processing unit (CPU), a graphics processing unit (GPU, or both), a main memory 604 and a static memory 606, which communicate with each other via a bus 608. The computer system 600 may further include a video display unit 610 (e.g., a liquid crystal display (LCD), a flat panel, a solid state display, or a cathode ray tube (CRT)). The computer system 600 may include an input device 612 (e.g., a keyboard), a cursor control device 614 (e.g., a mouse), a mass storage medium 616, a signal generation device 618 (e.g., a speaker or remote control) and a network interface device 620.

The mass storage medium 616 may include a computer-readable storage medium 622 on which is stored one or more sets of instructions (e.g., software 624) embodying any one or more of the methodologies or functions described herein, including those methods illustrated above. The computer-readable storage medium 622 can be an electromechanical medium such as a common disk drive, or a mass storage medium with no moving parts such as Flash or like non-volatile memories. The instructions 624 may also reside, completely or at least partially, within the main memory 604, the static memory 606, and/or within the processor 602 during execution thereof by the computer system 600. The main memory 604 and the processor 602 also may constitute computer-readable storage media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 624, or that which receives and executes instructions 624 from a propagated signal so that a device connected to a network environment 626 can send or receive voice, video or data, and to communicate over the network 626 using the instructions 624. The instructions 624 may further be transmitted or received over a network 626 via the network interface device 620.

While the computer-readable storage medium 622 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure.

The term “computer-readable storage medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a computer-readable storage medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium comprising computer instructions for:
establishing internet access through an internet service provider;
establishing a Generic Route Encapsulation (GRE) tunnel to a second communication system through the internet service provider;
establishing VRF functionality in a border router of the first communication system that uses MPLS protocol; and
routing a packet from the first communication system to the second communication system along the GRE tunnel according to a MPLS label of the packet and a VRF routing table.

2. The storage medium of claim 1, comprising computer instructions for providing routing information to the second communication system.

3. The storage medium of claim 1, comprising computer instructions for:
establishing another GRE tunnel to a third communication system through the internet service provider; and
routing another packet from the first communication system to the third communication system along the another GRE tunnel according to a MPLS label of the another packet and the VRF routing table.

4. The storage medium of claim 1, wherein the routing of the packet is according to an OSPF routing protocol.

5. The storage medium of claim 1, wherein the GRE tunnel is established utilizing an external border gateway protocol.

6. The storage medium of claim 1, comprising computer instructions for disabling a loop detection function of the first communication system.

7. The storage medium of claim 1, comprising computer instructions for indicating to one or more routers of the first communication system that a route is no longer reachable.

8. The storage medium of claim 7, wherein the one or more routers are a plurality of routers that utilize a label distribution protocol.

9. The storage medium of claim 1, wherein the packet is routed from a first communication device of the first communication system to a second communication device of the second communication system, and wherein the first or second communication devices comprise one among a router, a border router, a gateway, a set-top box (STB), and a computer.

10. A method of providing a communication service between first and second service providers, the method comprising:
establishing a logical tunnel to the first and second service providers utilizing an internet service provider; and
routing a packet along the logical tunnel between the first and second service providers according to a MPLS label of the packet and a VRF routing table.

11. The method of claim 10, comprising routing the packet from a first communication device of the first service provider to a second communication device of the second service provider, wherein the first and second communication devices comprise at least one among a router, a border router, a gateway, a set-top box (STB), and a computer.

12. The method of claim 11, wherein the logical tunnel is a GRE tunnel and wherein a network element of the first or second service providers:
establishes another GRE tunnel to a third service provider through the internet service provider; and
routes another packet to the third service provider along the another GRE tunnel according to a MPLS label of the another packet and the VRF routing table.

13. The method of claim 10, wherein the logical tunnel comprises one among a GRE tunnel and a L2TP tunnel.

14. The method of claim 10, wherein a network element of the first or second service providers utilizes OSPF routing protocol to route the packet.

15. The method of claim 10, wherein the logical tunnel is established utilizing an external border gateway protocol.

16. The method of claim 10, wherein a network element of the first or second service providers disables a loop detection function of the communication service.

17. The method system of claim 10, wherein a network element of the first or second service providers indicates to one or more routers of at least one of the first or second service providers that a route is no longer reachable.

18. The method system of claim 17, wherein the one or more routers are a plurality of routers that utilize a label distribution protocol.

19. A communication device, comprising a controller element to:
transmit a packet along a logical tunnel established through an internet service provider, wherein the route of the packet is managed according to a MPLS label of the packet and a VRF routing table.

20. The communication device of claim 19, comprising at least one among a router, a border router, a gateway, a set-top box (STB), and a computer.

21. The communication device of claim 19, wherein the packet is transmitted along a first communication system before reaching an infrastructure of the internet service provider, and wherein the packet is received by another communication device of a second communication system that is coupled to the first communication system by the logical tunnel.

22. The communication device of claim 21, wherein a loop detection function of the first and second communication systems is disabled during transmission of the packet.

23. The communication device of claim 21, wherein a network element of the first communication system indicates to one or more routers of the first communication system that a route is no longer reachable.

24. The communication device of claim 23, wherein the one or more routers are a plurality of routers that utilize a label distribution protocol.

25. The communication device of claim 19, wherein the logical tunnel comprises one among a GRE tunnel and a L2TP tunnel.

26. The communication device of claim 19, wherein the packet is managed according to OSPF routing protocol.

27. A network element of a first communication system, the network element comprising a controller element to:
receive a packet from a second communication system along a Generic Route Encapsulation (GRE) tunnel according to a MPLS label of the packet and a VRF routing table, wherein the GRE tunnel is established through an internet service provider.

28. The network element of claim 27, comprising a border router of the first communication system that uses MPLS protocol and VRF functionality.
